(19) United States
(12) Patent Application Publication
(10) Pub. No.: US 2019/0344767 A1
(43) Pub. Date: Nov. 14, 2019

(54) ELECTRO-HYDRAULIC POWER VEHICLE-BRAKE SYSTEM FOR AN AUTONOMOUSLY DRIVING LAND VEHICLE

(71) Applicant: Robert Bosch GmbH, Stuttgart (DE)

(72) Inventors: Alexander Bareiss, Immenstadt (DE); Juergen Reiner, Gestratz (DE); Thomas Zander, Oberstaufen (DE)

(21) Appl. No.: 16/406,647

(22) Filed: May 8, 2019

(30) Foreign Application Priority Data
May 9, 2018 (DE) 102018207212.4
Nov. 29, 2018 (DE) 102018220613.9

(51) Int. Cl. B60T 13/58; B60T 7/12; B60T 13/66; B60T 13/14; B60T 13/68

(52) U.S. Cl. CPC B60T 13/58; B60T 7/12; B60T 13/662; B60T 13/62; B60T 13/686; B60T 2270/402; B60T 13/142; B60T 13/14

(57) ABSTRACT

An electro-hydraulic power vehicle-brake system for a motor vehicle autonomously driving on public roads. A secondary brake unit is connected to a service brake unit so that in the event of a failure of the service brake unit, the vehicle brake system is able to be actuated using the secondary brake unit. In order to be able to rapidly build up a brake pressure with the aid of the secondary brake unit even with a cold and viscous brake fluid, brake fluid reservoirs are provided that are integrated into the secondary brake unit and are connected by short line lengths to hydraulic pumps of the secondary brake unit.

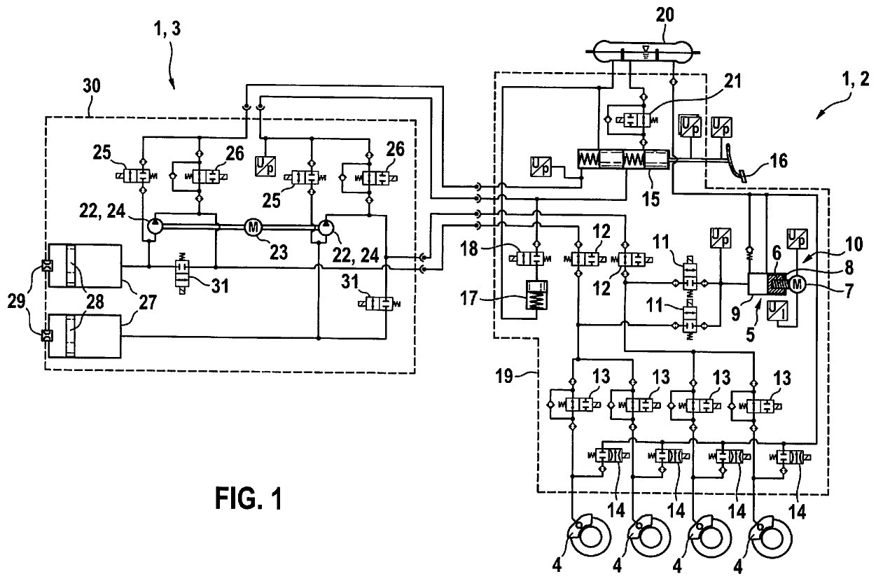

### FIELD OF THE INVENTION

The present invention relates to an electro-hydraulic power vehicle-brake system for a land vehicle which is driving in an autonomous manner on public roads, and it relates to a method relating to an electro-hydraulic power vehicle-brake system for a land vehicle.

### BACKGROUND INFORMATION

Autonomous driving up to a level 4 (driver may be prompted to intervene) and a level 5 (highest level; no driver necessary) requires a power vehicle-brake system featuring redundancies, which excludes a total failure of the vehicle-brake system with a probability bordering on certainty without requiring any driver intervention.

The published patent application German Published Patent Application No 10 2014220440 describes an electro-hydraulic power vehicle-brake system, which includes a service brake unit and a secondary brake unit. Both brake units include a separate power brake pressure generator having an electrically controllable pressure source and a brake-pressure control valve array for each wheel brake. The secondary brake unit is connected to the service brake unit, and hydraulic wheel brakes are connected to the secondary brake unit so that in a passive secondary brake unit, the wheel brakes are actuable through the secondary brake unit using the service brake unit, and in the event of an interruption or a failure of the service brake unit, the wheel brakes are able to be actuated using the secondary brake unit. The brake unit that is active in each case controls the wheel-brake pressures in the wheel brakes.

### SUMMARY

The electro-hydraulic power vehicle brake system according to the present invention is intended for autonomous driving up to levels 4 and 5 on public roads. Level 4 is also denoted as highly-automated driving and means that the control of a vehicle is permanently assumed by an electronic system, and a driver is prompted to intervene only when the system is no longer able to manage the driving tasks. Level 5 is also referred to as a full automation and requires no driver.

The vehicle brake system according to the present invention includes a service brake unit, to which one or more hydraulic wheel brake(s) is/are connected, and a secondary brake unit. As a rule, the wheel brake(s) is/are operated with the aid of the service brake unit, which is known as service braking. For the actuation of the wheel brake(s), the service brake unit has a brake pressure generator in order to generate a brake pressure, and it has one or more brake-pressure control valve array(s) by which the wheel-brake pressures in the wheel brakes are controlled. A “control” may also be understood as an open-loop control. The wheel-brake pressure is preferably controlled individually in each wheel brake but it is also possible to control wheel brake pressures in groups of wheel brakes or the wheel brake pressure of all wheel brakes jointly. A magnitude of the wheel brake pressure or pressures, and thus brake forces of the wheel brakes, is controlled. In addition, a slip control, an electronic stability program (often also referred to as an anti-skid control), automatic braking, distance control and the like are possible using the brake-pressure control valve array(s).

The service brake unit may include a muscular energy or power master brake cylinder as the brake pressure generator, the latter meaning a muscular-energy master brake cylinder including a brake booster, e.g., an underpressure or an electromechanical brake booster. Power braking is to be distinguished from secondary braking using the secondary brake unit when the service brake unit fails. In addition to or instead of the master brake cylinder, the service brake unit may include a power brake pressure generator, which may encompass a piston-cylinder unit, for example, whose piston is displaceable inside a cylinder with the aid of an electric motor via a rotation-translation converter gear, for instance. Another option for a power brake pressure generator is an hydraulic pump, which may be driven with the aid of an electric motor, for example.

The secondary brake unit us used for actuating the wheel brake(s) in the event of a fault or a failure of the service brake unit, it being possible to control the wheel brake pressures in the wheel brakes using the brake-pressure control valve array of the service brake unit if the brake-pressure control valve array is operative. The brake actuation using the secondary brake unit in the event of a fault or a failure of the service brake unit is referred to as a secondary braking. Because of it less complex structure, the secondary brake unit is basically not equipped with a brake-pressure control valve array, but further refinements of the present invention in which both the service brake unit and the secondary brake unit include a brake-pressure control valve array are possible.

The secondary brake unit includes a power brake pressure generator and a brake fluid reservoir, which is integrated into the secondary brake unit. “Integrated” does not describe a brake fluid reservoir placed on the secondary brake unit as it is known from master-brake cylinders, or a separate brake fluid reservoir, but instead refers to a brake fluid reservoir that is implemented as a bore in an hydraulics block of the secondary brake unit, for instance, or is accommodated in such a bore. The power brake pressure generator of the secondary brake unit is connected to the brake fluid reservoir of the secondary brake unit so that it is able to aspirate brake fluid from the brake fluid reservoir in order to generate the brake pressure. The integration of the brake fluid reservoir into the secondary brake unit allows for a short connection of the power brake pressure generator to the brake fluid reservoir at a low flow resistance. This improves an aspiration behavior and allows for a rapid buildup of brake pressure, in particular if a viscous brake fluid is involved at low temperatures.

Another advantage of the present invention is that the brake fluid reservoir of the secondary brake unit is charged with brake fluid together with the vehicle-brake system. Separate charging or replenishing of a separate brake fluid reservoir or of a brake fluid reservoir mounted on the secondary brake unit is unnecessary.

The service brake unit and/or the secondary brake unit preferably has/have an hydraulics block in each case. The hydraulics block is frequently a cuboidal component, which is normally made of metal but may also be produced from some other material such as plastic. Blind holes as receptacles for hydraulic components of the vehicle-brake system are provided in the hydraulics block. Such components are solenoid valves, whose hydraulic parts are typically situated in the respective receptacle of the hydraulics block and whose electromechanical parts such as the armature and solenoid coil project from the hydraulics block. The hydraulic parts of a solenoid valve as such are the actual valve, that is to say, a cutoff element, for example, and a valve housing including a valve seat. Additional hydraulic components, among others, are hydraulic pumps, hydraulic reservoirs, non-return valves and parts of pump drives. In addition, such hydraulics blocks have blind holes for the connection of brake lines using threaded nipples or self-clinch nipples. The blind holes that constitute the receptacles for the hydraulic components are developed with a stepped diameter in most cases. Via bores of the hydraulics block, the receptacles for the hydraulic components are connected to one another according to a hydraulic circuit layout of the vehicle-brake system or the service brake unit and/or the secondary brake unit, which may be denoted as an (hydraulic) interconnection. The drilling of the hydraulic block is Cartesian in most cases, which means that the bores are parallel and perpendicular to one another and, in a cuboid hydraulics block, parallel and perpendicular to surfaces and edges of the hydraulics block.

Preferably, the power brake pressure generator of the secondary brake unit is connected to the brake fluid reservoir by a short and/or straight line, e.g., a bore hole in a hydraulics block of the secondary brake unit. As a result, the connection of the power brake pressure generator of the secondary brake unit to the brake fluid reservoir has a low flow resistance. The term “short” denotes a line length of one or a few millimeters in this case and in particular a line that has a shorter length than the length of a self-clinch or threaded nipple for the connection of a brake line to a brake unit, a wheel brake or a master brake cylinder, for example.

The brake fluid reservoir of the secondary brake unit is preferably nonpressurized. This offers the advantage that no pressure in the brake fluid reservoir has to be monitored. A spring-loaded brake fluid reservoir or one acted upon by pressurized gas is also an option, in which case a pressure in the brake fluid reservoir has to be so low that it will not open an inlet valve of a piston pump as part of the power pressure generator, for example. In more general terms, a possible pressure in the brake fluid reservoir of the secondary brake unit must not lead to a flow of brake fluid through the power brake pressure generator.

According to the method of the present invention, the brake fluid reservoir of the secondary brake unit is charged using a charge and check valve with the aid of the power brake pressure generator of the service brake unit, and possibly evacuated in advance. The charging and/or evacuating, for instance, may be adapted for changing the brake fluid, to ensure a completely charged brake fluid reservoir and/or in order to remove possible gas bubbles from the brake fluid reservoir of the secondary brake unit. Also conceivable is charging and/or evacuating using the power brake pressure generator of the service brake unit or the master brake cylinder.

A further development provides for an assessment of the charging and/or evacuating of the brake fluid reservoir of the secondary brake unit. For example, it is possible to measure a duration of the charging and/or evacuation, a pressure characteristic, a volume flow, a duration until a specified pressure has been reached, and/or a duration of the charging and/or evacuation, whereupon an assessment may be made on that basis as to whether the brake fluid reservoir of the secondary brake unit is fully charged or was fully charged prior to the charging and/or evacuating, and/or whether the charging and/or evacuation of the brake fluid reservoir of the secondary brake unit has the expected or usual characteristic or a characteristic that points to an error such as gas bubbles or a brake fluid reservoir that is not charged or charged only incompletely, for example.

All features disclosed in the description and the drawing may be realized individually or in basically any combination in specific embodiments of the present invention. As a matter of principle, embodiments of the present invention are conceivable that do not include all of the features but only a single feature or a plurality of features of a claim.

### BRIEF DESCRIPTION OF THE DRAWING

The FIGURE shows a hydraulic circuit diagram of an electro-hydraulic power vehicle-brake system according to the present invention.

### DETAILED DESCRIPTION

Electro-hydraulic power vehicle-brake system 1 according to the present invention shown in the drawing is intended for a land vehicle that travels in an autonomous manner up to a level 4 or 5 on public roads, or in other words, a passenger car. Level 4 means autonomous driving in which a driver may be prompted to intervene, and level 5, the highest level, refers to autonomous driving that requires no driver intervention.

Power vehicle-brake system 1 has a service brake unit 2 and a secondary brake unit 3. Service brake unit 2 is provided for a brake actuation, and secondary brake unit 3 is provided for a brake actuation in the event of a fault or a failure of service brake unit 2. Via brake lines, i.e. four in the exemplary embodiment, hydraulic wheel brakes 4 are connected to service brake unit 2. Secondary brake unit 3 is connected via brake lines to service brake unit 2 in such a way that wheel brakes 4 are also actuable using secondary brake unit 3. Service brake unit 2 and secondary brake unit 3 constitute a separate component group in each case, which may be installed at different locations, such as in an engine compartment of the passenger car.

Vehicle-brake system 1 according to the present invention is developed as a dual-circuit brake system, and its brake units 2, 3 are developed as dual-circuit brake units. Two wheel brakes 4 are allocated to a brake circuit in each case.

Service brake unit 2 has a piston-cylinder unit 5, whose piston 6 is displaceable in a cylinder 9 with the aid of an electric motor 7 via a screw drive 8 as a rotation/translation converter gear. Electric motor 7, screw drive 8 and piston-cylinder unit 5 form a power brake pressure generator 10 of service brake unit 2 for the generation of a brake pressure for service braking. The service braking is the conventional and provided brake actuation. Power-brake pressure generator 10 is connected to the two brake circuits by way of service-brake valves 11 between isolation valves 12 and inlet valves 13.

Service brake unit 2 has an inlet valve 13 and an outlet valve 14 for each wheel brake 4, by which wheel-brake pressures in each wheel brake 4 are able to be individually controlled. In this way, the wheel-brake pressures in wheel brakes 4, and thus brake forces of wheel brakes 4, are controllable without slip during a normal driving operation. In addition, slip controls such as an anti-lock braking protection and traction controls, driving stability controls, which are commonly also referred to as anti-skid controls, automatic braking, distance controls and the like are possible. Such controls are already known and will not be discussed here in greater detail. Inlet valves 13 and outlet valves 14 may also be considered wheel-brake pressure control valve arrays.

In addition to the power brake pressure generator 10, service brake unit 2 has master brake cylinder 14, which is able to be actuated by muscle force and to which wheel brakes 4 are connected via isolation valves 12 and inlet valves 13. Service brake unit 2 has an isolation valve 12 in each brake circuit and an inlet valve 13 and an outlet valve 14 for each wheel brake 4. Master brake cylinder 15 is used as a setpoint generator for the wheel-brake pressures to be set in wheel brakes 4 during service braking in the case of a driver operation. The brake pressure is generated with the aid of power brake pressure generator 10 both in a driver operation and in an autonomous driving operation. During service braking, master brake cylinder 15 is hydraulically separated from wheel brakes 4 by closing isolation valves 12.

As stated, master brake cylinder 15 is used as a setpoint generator for the wheel-brake pressures during service braking in a driver operation during which the brake pressure is generated using a power brake pressure generator 10. In the event of a failure of power brake pressure generator 10, the brake pressure is able to be generated by actuating master brake cylinder 15. This is what is known as secondary braking using muscle power, and master brake cylinder 15 may thus also be considered a muscle-power brake pressure generator.

To ensure that brake fluid is displaceable from master brake cylinder 15 when isolation valves 12 are closed and that pistons of master brake cylinder 15 and a brake pedal 16 are able to be moved, service brake unit 2 includes a pedal-travel simulator 17, which is connected via a simulator valve 18 to a brake circuit of master brake cylinder 15. Pedal-travel simulator 17 is a piston-cylinder unit including a piston acted upon by a spring.

In the described and illustrated specific embodiment of the present invention, isolation valves 12 and inlet valves 13 are 2/2 directional solenoid valves that are open in their currentless basic positions, and service-brake valves 11 of power brake pressure generator 10, outlet valves 14 and simulator valve 18 are 2/2 directional solenoid valves that are closed in their currentless basic positions. For a better control quality of the wheel brake pressures, inlet valves 13 are developed as proportional valves, but this is not mandatory for the present invention.

The hydraulic components of service brake unit 2 of electro-hydraulic power vehicle-brake system 1 according to the present invention, that is to say, valves 11, 12, 13, 14, 18 of power brake pressure generator 10, master brake cylinder 15, pedal-travel simulator 17, and further components such as pressure sensors, are situated in the receptacles of an hydraulics block 19 of service brake unit 2; they are connected to one another via drilled bores of hydraulics block 19 according to the illustrated hydraulic circuit diagram of vehicle brake system 1 or service brake unit 2.

A nonpressurized brake fluid reservoir 20, as it is known from conventional master brake cylinders, is placed on hydraulics block 19, and master brake cylinder 15 and power brake pressure generator 10 are connected to it. A valve 21 is provided between brake fluid reservoir 20 and master brake cylinder 15 in one of the two brake circuits.

Secondary brake unit 3 has an hydraulic pump 22 in each of its two brake circuits, which are able to be driven by a shared electric motor 23. Hydraulic pumps 22 are reciprocal piston pumps, but other hydraulic pumps such as gear-type pumps are also conceivable. Hydraulic pumps 22 together with electric motor 23 form power brake pressure generator 24. Suction sides of hydraulic pumps 22 of secondary brake unit 3 are connected to the two brake circuits of master brake cylinder 15 of service brake unit 2 via suction valves 25 and the already mentioned brake lines by which secondary brake unit 3 is connected to service brake unit 2. In the same way, the pressure sides of hydraulic pumps 22 of secondary brake unit 3 are connected via pressure valves 26 to master brake cylinder 15 of service brake unit 2.

In addition, via brake lines by which secondary brake unit 3 is connected to service brake unit 2, the pressure sides of hydraulic pumps 22 of secondary brake unit 3 are connected without an interconnection of valves to isolation valves 12 of service brake unit 2. This allows for an actuation of wheel brakes 4 by the generation of brake pressure using hydraulic pumps 22 of secondary brake unit 3, which form its power brake pressure generator 24. Wheel brake pressures in wheel brakes 4 are controllable by inlet valves 13 and outlet valves 14 of service brake unit 2, which form brake-pressure control valve arrays, provided these valves 13, 14 and their controls are operable. Using hydraulic pumps 22 of secondary brake unit 3, which form power brake pressure generator 24, the brake pressure is generated in the event of a fault or a failure of service brake unit 2. Such braking is known as secondary braking.

In the described and illustrated specific embodiment of the present invention, suction valves 25 of secondary brake unit 3 are developed as 2/2 directional solenoid valves, which are closed in their currentless basic positions, and pressure valves 26 are developed as 2/2 directional solenoid valves, which are open in their currentless basic positions. In secondary braking, suction valves 25 are opened so that hydraulic pumps 22 of secondary brake unit 3 are able to aspirate brake fluid through master brake cylinder 15 from brake fluid reservoir 20 of service brake unit 2. In addition, pressure valves 26 are closed in order to generate the pressure at the wheel brakes.

Secondary brake unit 3 has brake fluid reservoirs 27 to which the suction sides of hydraulic pumps 22 are connected. In the illustrated and described specific embodiment of the present invention, brake fluid reservoirs 27 are piston-cylinder units, whose pistons 28 are neither acted upon by springs nor gas pressure. In the specific embodiment, pistons 28 communicate with an environment via throttles 29 so that brake fluid reservoirs 27 of secondary brake unit 3 are nonpressurized. Other embodiments of brake fluid reservoirs 27 are conceivable such as a bellows reservoir or a diaphragm reservoir. Also possible is a low spring-, gas-pressure or other application of pistons 28 of brake fluid reservoirs 27, which, however, is so low that no brake fluid is displaced from brake fluid reservoirs 27 by hydraulic pumps 22.

Hydraulic pumps 22, which form brake pressure generators 24 of secondary brake unit 3, receive brake fluid having a low flow resistance via brake fluid reservoirs 27, thereby allowing for a rapid buildup of brake pressure even if the brake fluid is cold and viscous.

For a charging and/or evacuation process, brake fluid reservoirs 27 of secondary brake unit 3 are connected via charge and check valves 31 to power brake pressure generator 10 of service brake unit 2. In the illustrated and described specific embodiment of the present invention, brake fluid reservoirs 27 of secondary brake unit 3 are connected by charge and check valves 31, the brake lines between secondary brake unit 3 and service brake unit 2, by which the pressure sides of hydraulic pumps 22 of power-brake unit 3 to isolation valves 12 of service brake unit 2 and service-brake valves 11 of service brake unit 2, to power brake pressure generator 10 of service brake unit 2, so that brake fluid reservoirs 27 of secondary brake unit 3 are able to be charged and evacuated by opening said valves 11, 12, 31 using power brake pressure generator 10 of service brake unit 2. For the charging and evacuation of brake fluid reservoirs 27 of secondary brake unit 3, pressure valves 26 of secondary brake unit 3 are closed and suction valves 25 remain closed. Inlet valves 13 of service brake unit 2 are preferably closed as well. Brake fluid reservoirs (27) may be charged and preferably evacuated in advance using power brake pressure generator 10 of service brake unit 2 in order to change the brake fluid, to determine whether they are fully charged, to fully charge them, and/or to ensure that they are fully charged, to remove gas bubbles. In the illustrated and described specific embodiment of the present invention, charge and check valves 31 are 2/2 directional solenoid valves, which are closed in their currentless basic positions.

The charging and evacuating of brake fluid reservoirs 27 of secondary brake unit 3 may also be accomplished with the aid of master brake cylinder 15 of service brake unit 2 and/or with the aid of hydraulic pumps 22 of secondary brake unit 3, which form its power brake pressure generator 24. For the charging with the aid of master brake cylinder 15, isolation valves 12 are preferably closed and the other valves remain in their illustrated currentless basic positions. For the charging with the aid of power brake pressure generators 24 of secondary brake unit 3, suction valves 25 are open so that power brake pressure generators 24 are able to aspirate brake fluid through master brake cylinder 15 from brake fluid reservoirs 20, pressure valves 26 being closed, charge and check valves 31 being opened, and isolation valves 12 preferably being closed as well.

A characteristic of the charging and/or the evacuation of brake fluid reservoirs 27 of secondary brake unit 3 is able to be evaluated in order to ascertain whether it is in the usual or expected form or whether it deviates, and errors may be inferred such as brake fluid reservoirs 27 that are not charged or not fully charged or have gas bubbles. For example, a pressure characteristic, a volume flow, a duration and/or a pressure achieved during the charging and/or evacuation of brake fluid reservoirs 27 following a predefined time are able to be evaluated.

The hydraulic components of secondary brake unit 3, i.e. hydraulic pumps 22, valves 25, 26, 31, brake fluid reservoirs 27, and further components such as pressure sensors, are situated in an hydraulics block 30 of secondary brake unit 3, and connected to one another by drilled bores of hydraulics block 30 according to the illustrated hydraulic circuit diagram, which may also be denoted as an interconnection of hydraulic components 22, 25, 26, 27. The placement of brake fluid reservoirs 27 of secondary brake unit 3 in respective hydraulics block 30 may also be understood as an integration of brake fluid reservoirs 27 into secondary brake unit 3 or its hydraulics block 30. Brake fluid reservoirs 27 may be completely inserted in hydraulics block 30 or may also partially project from hydraulics block 30.

Connections, i.e. bores in hydraulics block 30 of secondary brake unit 3, of brake fluid reservoirs 27 of secondary brake unit 3 to the suction sides of hydraulic pumps 22 forming power brake pressure generators 24 are short, between approximately 1 mm and 5 mm, 6 mm or less than 10 mm, and are preferably straight in order to achieve a low flow resistance between brake fluid reservoirs 27 and hydraulic pumps 22.

What is claimed is:

1. An electro-hydraulic power vehicle-brake system for a land vehicle autonomously driving on a public road, comprising:
at least one hydraulic wheel brake;
a service brake unit to which the at least one hydraulic wheel brake is connected and including a brake pressure generator for generating a brake pressure;
a brake-pressure control valve array for controlling a wheel brake pressure acting on the at least one hydraulic wheel brake;
a service brake unit; and
a secondary brake unit connected to the service brake unit so that in the event of a failure of the service brake unit, the at least one hydraulic wheel brake is able to be actuated using the secondary brake unit, wherein:
the secondary brake unit includes a power brake pressure generator for generating a brake pressure applied to the at least one hydraulic wheel brake, and
the secondary brake unit includes a brake fluid reservoir integrated into the secondary brake unit and to which the power brake pressure generator of the secondary brake unit is connected so that the power brake pressure generator of the secondary brake unit is able to aspirate brake fluid from the brake fluid reservoir in order to generate the brake pressure.

2. The electro-hydraulic power vehicle-brake system as recited in claim 1, wherein the secondary brake unit includes an hydraulics block in which the brake fluid reservoir is situated.

3. The electro-hydraulic power vehicle-brake system as recited in claim 1, wherein the power brake pressure generator of the secondary brake unit is connected to the brake fluid reservoir by a line that is at least one of short and straight.

4. The electro-hydraulic power vehicle-brake system as recited in claim 1, wherein the brake fluid reservoir is nonpressurized.

5. The electro-hydraulic power vehicle-brake system as recited in claim 1, wherein the secondary brake unit includes one of a piston-cylinder unit, a bellows reservoir, and a diaphragm reservoir as a brake fluid reservoir.

6. The electro-hydraulic power vehicle-brake system as recited in claim 1, wherein at least one of the power brake pressure generator and the brake fluid reservoir of the secondary brake unit is connected to at least one of the brake pressure generator and a brake fluid reservoir of the service brake unit.

7. The electro-hydraulic power vehicle-brake system as recited in claim 1, wherein at least one of:
a suction side of the power brake pressure generator of the secondary brake unit is connectable via a first valve to at least one of the brake pressure generator and the brake fluid reservoir of the service brake unit, and
a pressure side of the power brake pressure generator of the secondary brake unit is separable by a second valve from at least one of the brake pressure generator and a brake fluid reservoir of the service brake unit.

8. The electro-hydraulic power vehicle-brake system as recited in claim 1, wherein:
the secondary brake unit includes a charge and check valve, by which the brake fluid reservoir of the secondary brake unit is connected to at least one of the power brake pressure generator of the secondary brake unit and the brake pressure generator of the service brake unit, so that at least one of the power brake pressure generator of the secondary brake unit and the brake pressure generator of the service brake unit is able to convey brake fluid into a brake fluid reservoir of the secondary brake unit.

9. A method for at least one of charging and evacuating a brake fluid reservoir of a secondary brake unit, comprising:
opening a charge and check valve; and
at least one of charging and evacuating the brake fluid reservoir of the secondary brake unit using a one of brake pressure generator of a service brake unit and a power brakepressure generator of the secondary brake unit.

10. The method as recited in claim 9, further comprising evaluating the at least one of the charging and evacuating.
